(19) United States
(12) Patent Application Publication
(10) Pub. No.: US 2021/0088171 A1
(43) Pub. Date: Mar. 25, 2021

(54) SYSTEM AND METHOD FOR FORMING A PIPE ASSEMBLY

(71) Applicant: SHELL OIL COMPANY, HOUSTON, TX (US)

(72) Inventors: Petrus Cornelis KRIESELS, Amsterdam (NL); Johannes Harmannus BRINKER, Joure (NL); Lieuwe Tjeerd VAN DER PLAATS, Joure (NL); Dirk Jan VAN DALFSEN, Rijswijk (NL); Heather Laurie GOWER, Rijswijk (NL); Jesper Wilhelmus WENTINK, Amsterdam (NL); Osman Ali CIFTCI, Rijswijk (NL)

(21) Appl. No.: 16/961,468

(22) PCT Filed: Jan. 8, 2019
(86) PCT No.: PCT/EP2019/050325

§ 371 Date: Jul. 10, 2020

(30) Foreign Application Priority Data
Jan. 10, 2018 (EP) 18150924.1

(51) Int. Cl. F16L 58/10; F16L 9/147; B32B 1/08; B32B 7/12

(52) U.S. Cl. CPC F16L 58/1036; F16L 9/147; B32B 2597/00; B32B 7/12; B32B 1/08

(57) ABSTRACT

The invention relates to a system and method for forming a pipe assembly. The method comprises: providing a composite pipe (112) having an inner diameter; providing a liner (110) having a first outer diameter which is smaller than the inner diameter of the composite pipe; placing the liner (110) in the composite pipe (112); and expanding the liner such that the liner has a second outer diameter which is greater than the first outer diameter, and an outer surface of the liner is in contact with an inner surface of the composite pipe, so as to form a pipe assembly including said composite pipe and said liner.

### FIELD OF THE INVENTION

The present invention relates to a system and method for forming a pipe assembly.

### BACKGROUND TO THE INVENTION

Pipelines are used for the transportation of pipe contents such as gases, liquids and even finely divided solids. Examples of the pipe contents include hydrocarbons which are often of high temperature (e.g., 175 degree C. or even higher) and high pressure (e.g., 1400 bars or higher). In some cases, the pipe contents may also be highly corrosive, for instance due to the combination of hydrocarbons, CO₂ and/or H₂S in the presence of water.

Currently available composite pipes may not withstand such harsh conditions and an improvement is therefore desired.

### SUMMARY OF THE INVENTION

To that end, in one aspect of the invention, there is provided a method for forming a pipe assembly, comprising: a. providing a composite pipe having an inner diameter; b. providing a liner having a first outer diameter which is smaller than the inner diameter of the composite pipe; c. placing the liner in the composite pipe; and d. expanding the liner such that the liner has a second outer diameter which is greater than the first outer diameter, and an outer surface of the liner is in contact with an inner surface of the composite pipe, so as to form a pipe assembly including said composite pipe and said liner.

In another aspect of the invention, there is provided a system for forming a pipe assembly, comprising: a first device configured to place a liner in a composite pipe, the liner having a first outer diameter which is smaller than an inner diameter of the composite pipe; a second device configured to expand the liner such that the liner has a second outer diameter which is greater than the first outer diameter, and an outer surface of the liner is in contact with an inner surface of the composite pipe, so as to form a pipe assembly including said composite pipe and said liner.

In another aspect of the invention, there is provided a pipe assembly formed by the aforementioned method or using the aforementioned system.

### BRIEF DESCRIPTION OF THE DRAWINGS

These and other features and advantages of the system and method will be further described below with reference to examples and the appended drawings. The drawings depict one or more implementations in accordance with the present teachings, by way of example only, not by way of limitation. In the drawings, like reference numerals refer to the same or similar features, elements, or steps. Scales in the drawings are illustrative only.

FIG. 1a illustrates a cross section view of a composite pipe.

FIG. 1b illustrates a longitudinal section view of a pipe assembly formed by expanding a liner placed in a composite pipe.

FIG. 2 is a flow chart of a process for making a liner.

FIG. 3 is an illustration of a metallic strip used in the process shown in FIG. 2 and a liner formed by the strip.

FIG. 4 is a flow chart of a method for forming a pipe assembly.

FIG. 5 is a block diagram illustratively showing functional elements of a system for forming a pipe assembly.

FIG. 6 is a block diagram illustratively showing functional elements of a second device.

FIG. 7 shows perspective schematic view and a longitudinal section view of an expander.

FIG. 8 illustrates a cross section view of composite pipe with a liner placed therein before expansion.

FIG. 9 is an illustration of a flattened part of a liner.

FIG. 10 is an illustration of a roll forming street configured to fold a flattened part of a liner into a C-shape.

FIG. 11 is an illustration of a composite pipe with a liner placed therein, the liner has a flattened part.

FIGS. 12 illustrates a second device according to an example.

FIGS. 13a-13c illustrate one section of a pipe assembly at different moments in time when a second device is guided through the inside of a liner placed in a composite pipe.

### DETAILED DESCRIPTION OF THE INVENTION

A pipeline system is known as a line of pipe for conveying liquids, gases, or even finely divided solids relating to the production, injection and/or transportation of oil, natural gas, chemicals, waste products, food or beverage products. The system and method according to various examples of the invention are suitable for forming a pipe assembly which may be installed to a pipeline system.

The system and method make use of a composite pipe which is formed by any one of the following:

1. multiple layers made of different materials;

2. a composition of materials mixing e.g. polymer and reinforcement materials such as fibers; or

3. weaving with different materials.

A multi-layer composite pipe may have an inner most layer which is made of polymeric material to generate a gas and liquid pressure tight conduit and to obtain insulation from the external environment. Other layers might have other materials, for example fibrous materials such as glass fiber, Kevlar/aramid type fibers or similar, carbon fiber or other reinforcing materials such as steel threads, to enhance the strength, stiffness, impact resistance or environmental resilience of the pipe. The individual layers may be bonded or woven to create one composite product. Examples of multi-layer composite pipes include, for instance, steel plastic composite pipes formed by two High Density Polyethylene (“HDPE”) layers separated by a steel layer. Applicant has found that the polymeric material could be permeable to or even reactable with hydrocarbons especially at elevated temperatures, causing damages to the inner surface of the pipe and leakage problems. Applicant has also found that hydrocarbons that leak out of polymeric layer might react with an adhesive layer set between the polymeric layer and e.g., a metal reinforcement layer. These problems can be solved by the method and system provided herein.

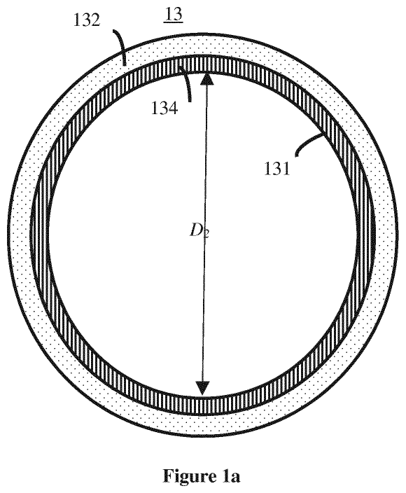

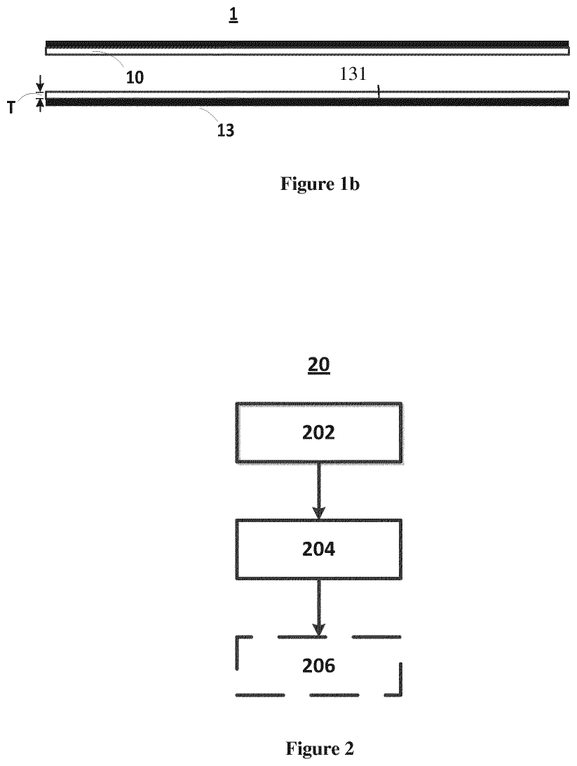

FIG. 1a illustrates a cross section view of a composite pipe. The pipe 13 has two layers, an outer layer 132 and an inner layer 134 which are made of different materials. In an example, the inner layer 134 is made of polymeric material, and the outer layer is made of metallic material such as steel. The inner diameter of the inner layer 134 defines the inner diameter D₂ of the composite pipe 13. The inner surface of the inner layer 134 forms the inner surface 131 of the composite pipe 13.

As will be further described in detail later in the context, the applicant found the system and method are applicable to form a pipe assembly using various types of composite pipes, additional effects/results are achievable if the inner surface is at least partially formed by polymeric material.

FIG. 1b is a longitudinal section view of a pipe assembly formed by expanding a liner placed in a composite pipe. Method and system according to embodiments of the present invention can be used to form such a pipe assembly to e.g., protect the composite pipe.

The liner 10 might be a thin-walled tubular object of a considerable continuous length. In different examples, the continuous length of the liner 10 could be about 100 meters, about several hundred meters, or even about 1,000 meters. Thickness T of the liner wall is for instance about 0.5 mm or be selected otherwise as needed.

The liner 10 can be made of various materials selected according to the actual applications. Typically, the liner 10 is made of corrosion resistant alloy (“CRA”), which may consist at least some of the following metals: Chrome, Stainless steel, Cobalt, Nickel, Iron, Titanium and Molybdenum. When combined, these metals can promote corrosion resistance and offer reliable protection from corrosion. Depending on the material choice of the liner 10, high corrosion resistance is possible to cope with highly corrosive pipe contents. With the liner 10 cladding the inner surface 131 of the composite pipe 13, the requirement for the corrosion resistance of the composite pipe 13 itself is significantly lowered, more materials hence become available for making composite pipes, esp., the inner most layer of multi-layer composite pipes.

The inner surface 131 of some composite pipes may be at least partially formed by a polymeric material such as HDPE. Many types of such polymeric materials may be permeable to pipe contents such as hydrocarbons especially at elevated temperatures, e.g., 85-90 degree C. If the inner surface 131 contacts directly with the hydrocarbons, the hydrocarbons might partly or fully diffuse into the polymeric material, external contents may also leak in via the inner surface 131 and then mix with the hydrocarbons. Some composite pipes may have an adhesive layer outside the inner surface, e.g., outside the inner most layer, which could be reactable with and get attached by hot hydrocarbons. By providing the liner 10, which is made of materials such as CRA that are impermeable for the pipe contents, the formed pipe assembly 1 prevents partial or full diffusion of the pipe contents into the polymeric material of the composite pipe 13 and prevents external contents from leaking in and mixing with the pipe contents. The adhesive layer is also protected from the hydrocarbons in this way.

Separating the pipe contents from the composite pipe 13 by the liner 10 also prevents negative effects of pipe contents of a relatively high temperature on polymeric material of the composite pipe especially that at or near the inner surface 131 by setting up a barrier and consequently increases the maximum allowable working temperature of the composite pipe 13. One or more layers of the composite pipe 13 may have high thermal expansion coefficients. Setting such a barrier by the liner 10 could manage the extent to which those pipe layers tend to thermally expand and thereby lower the load on other layer(s) outside the layer having a high thermal expansion coefficient.

The liner 10 may present a good mechanical strength to withstand high pressures from the inside, and reinforce the composite pipe 13. It is hence possible to form a pipe assembly (also referred to as a lined pipe assembly or a lined pipe hereinafter) using a composite pipe having a lower mechanical strength. For instance, the composite pipe may therefore does not require or only require a much thinner metallic layer to achieve an acceptable robustness. The composite pipe 13 may also stabilize and protect the liner 10 from outside. The pipe assembly 1 formed in this way thus creates a robust assembly with a high collapse rate for the liner 10. The liner 10 in turn creates an enlarged burst pressure.

Being as good as a pipe made purely by CRA in terms of e.g., corrosion resistance, the pipe assembly 1 formed by combining a composite pipe 13 and a CRA liner 10 comes at a price comparable to a normal carbon steel pipe.

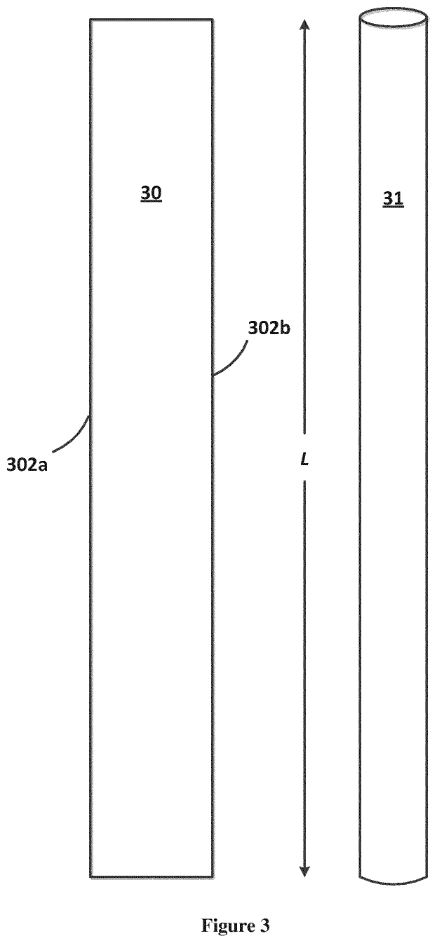

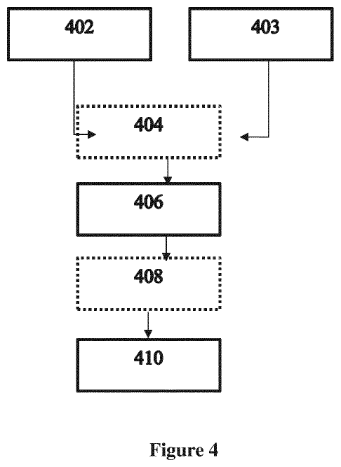

FIG. 2 is a flow chart of a process 20 for making a liner. An example of the liner is shown in FIG. 3. The liner 31 is suitable for the system and method for forming a pipe assembly. In this exemplary process 20, firstly, in step 202, a metallic strip 30 is formed by e.g., metal forming. A length L of the metallic strip 30 may be decided based on the desired length of the liner. The formed metallic strip 30 has two longitudinal edges 302a and 302b. In step 204, the metal strip 30 is further processed into a tubular shape and the two edges 302a and 302b are welded or joined together by other suitable means, to obtain an enclosed shape, i.e., a tubular object having a closed cross-section, namely a liner 31. After step 204, a liner 31 having a continuous length L is made. L may be close or comparable to the length of the composite pipe 13 that is to be cladded by the liner 31. Preferably, liner 31 is not formed by joining liner sections and is therefore free of circular connections/joints which are potential leak paths for pipe contents. Because length L is not interrupted by any circular connections/joints, it may be referred to as a continuous length.

Process 20 further includes an optional step 206 after step 204. In step 206, the liner 31 may be further flattened or collapsed over at least a part of its continuous length L. In an example, the liner might be flattened over its entire length. Therefore, a longitudinal end of the liner might need to be suitably opened before a second device (to be described below) can be inserted therein. Alternatively, example, the whole liner may be flattened except for a longitudinal end portion. The end portion is left un-flattened to receive the second device which is then guided through the inside of the liner.

The process 20 may include one more step, which is not shown in FIG. 2. In terms of time sequence, this step is preferably after step 202, before step 206, before or after step 204. In that step, adhesive coating is applied to one or both surfaces/walls of the metallic strip 30 or liner 31. A person skilled in the art would appreciate that, when the coated liner 31 is placed in the composite pipe and expanded, this coating will establish an adhesive bonding between the liner and the composite pipe, which may enhance the stability of the pipe assembly, with or without an interference fit.

In different examples, the composite pipe used to form a pipe assembly might be formed by one single continuous pipe, or multiple sections joined together by means of welding or flanged connections. The liner may suitably protect the welding or other connections as well. Because the liner has a continuous length suitable for lining the composite pipe, the liner can be inserted after the pipe sections are joined together, and the operator only needs to weld the pipe sections, which considerably simplify the operation.

Preferably, by eliminating the circular joints/connections, the liner may have a smooth surface along length L. This may lead to less adhesion of dirt or other disagreeable content on the surface which may otherwise reduce the internal diameter of the pipe assembly. The method and system are therefore also useful for saving maintenance cost and efforts.

The continuous length L of the liner is sufficiently long for lining the composite pipe, or only a very limited number of such liners need to be joined, which number is considerably reduced comparing to simply inserting solid/rigid CRA pipes into the composite pipe. In an example, the continuous length of the liner is over 100 meters, and may be several hundred meters or even over 1,000 meters.

Because no or very limited onsite welding is required for the liner, in situ lining becomes more attractive. Thus, operators will not have to line the composite pipe offsite (e.g., in a workshop) and then coil the lined pipeline (a pipe assembly) for transportation to the site where the pipe is installed to a pipeline system. Coiling a lined pipe (i.e., a composite pipe with a liner placed and expanded therein as mentioned) may create wrinkles on the liner material, the composite pipe and the liner material lose good fit/connection around those wrinkles. The disagreeable wrinkles may also reduce the internal diameter for transporting pipe content, interrupt the flow of the pipe content, etc. Although coiling an elongated object to a smaller radius may result in a smaller drum size which is good for road transportation, the operators would not be allowed to do so in view of this wrinkle problem which gets worse when the lined composite pipe is coiled to a smaller radius.

Comparing to any solution which requires lining pipe sections separately and joining the lined sections together by welding, the system and method of certain embodiments of the invention is of benefit because it is no longer needed to weld two different materials, e.g., CRA in the liner and carbon steel in the composite pipe at the same time, which is very difficult and complicated.

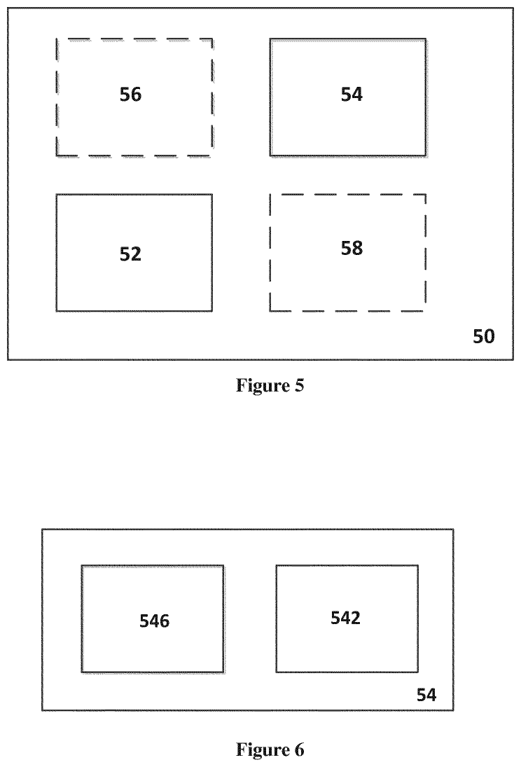

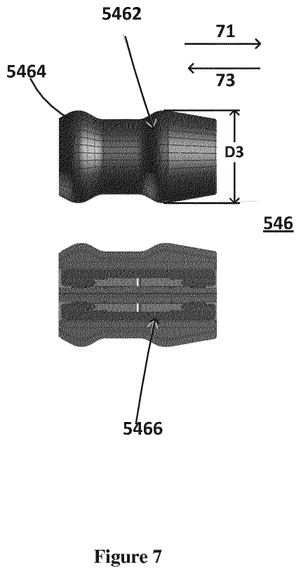

FIG. 4 is a flow chart of a method 40 for forming a pipe assembly. FIG. 5 is a block diagram illustratively showing functional elements of a system 50 for forming a pipe assembly. Method 40 and system 50 have corresponding features and will be therefore jointly described as follows. The method and system are designed to form the pipe assembly at a site where the pipe assembly is installed to a pipeline system, the forming process being an in-situ part of the installation process. In an example, the composite pipe is formed at a first site, the liner is formed at a second site. The liner and the composite pipe are transported, by road transportation, to a third site where the pipe assembly is to be formed and installed to a pipeline system. Without loss of generality, the first site, the second site and the third site can be different from each other.

At the third site, the composite pipe can be laid on location by, for example, laying it onto the ground directly, laying it onto a shallow sea bed, on sleepers or laying it into a ditch which is covered after commissioning. The liner and related devices and equipment are transported to the third site. In an example, the liner may have been coiled into a drum for transportation from the first site to the third site, and a line up unit (not shown) can be installed at the third site to facilitate a conduit from the drum to one end of the composite pipe, to get the liner into the composite pipe easier.

As shown in FIG. 4, method 40 includes steps 402, 403, 406 and 410, and optional steps 404 and 408. An exemplary time sequence of the steps is as illustrated in FIG. 4. As shown in FIG. 5, system 50 includes a first device 52 and a second device 54. System 50 may further include a third device 56 and a fourth device 58 which are both optional. Step 406 corresponds to the function of the first device 52, step 410 corresponds to the function of the second device 54, the optional step 404 corresponds to the function of the optional third device 56, and the optional step 408 corresponds to the function of the optional fourth device 58. Method 40 and system 50 will be described in detail with reference to several examples.

### EXAMPLE 1: THE LINER DOES NOT HAVE A FLATTENED PART

In this example, a liner used for forming a pipe assembly does not have a flattened part. Therefore, in step 402, a composite pipe having an inner diameter (e.g., D₂) is provided, and in step 403, a liner is provided, the liner has a first outer diameter which is smaller than the inner diameter of the composite pipe. In this example, the liner does not have a flattened part. The first outer diameter is smaller than a second outer diameter which will be described below.

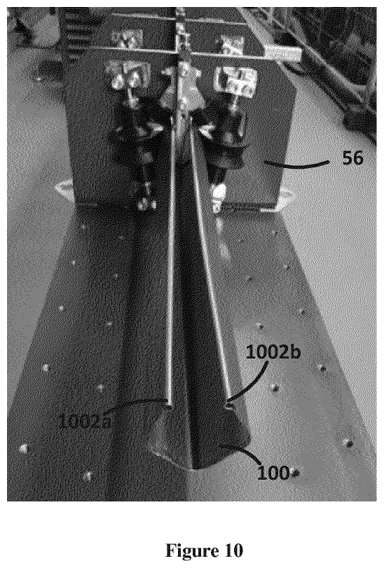

Method 40 then proceeds to step 406, in which the first device 52 places the liner inside the composite pipe. FIG. 8 illustrates a cross section view of a pipe assembly in which a liner 80 is placed in a composite pipe 83 and has not been expanded, thus the outer surface of the liner 80 is not in contact with the inner surface of the composite pipe 83. To ease the step of placing the liner 80 inside the pipe 83, the first outer diameter of the liner 80, e.g., the external diameter D₁, is smaller than the internal diameter D₂ of the composite pipe 83, and a space 82 is left between the composite pipe 83 and the liner 80. Basically, it is like one tubular object (the liner) placed in another tubular object (the composite pipe). D₂ may be referred to an initial inner diameter of the composite pipe, which however may not be necessarily changed by the expansion of the liner. By expanding the liner to have a second outer diameter which is greater than the first outer diameter, the outer surface of the liner is in contact with the inner surface of the composite pipe, and the second diameter could be equal to or greater than D₂.

Step 406 and the first device 52 may be implemented in various ways, examples include the following:

a) Step 406 may include using a guide wire to pull the liner into the composite pipe, the guide wire has been inserted into the pipe beforehand. The first device 52 may therefore be implemented by the guide wire and a tractor pulling the guide wire. Or,

b) Step 406 may include attaching a piston-like component (for example, a pipeline pig or a device with sealing elements) to the liner and pushing or pressurizing the piston-like component into an end of the composite pipe from where the liner is thereby inserted into the pipeline following the piston-like component. The first device 52 may thus be implemented by the piston-like component and a device pushing/pressurizing it.

After step 406, method 40 proceeds to step 410, in which the liner 80 is expanded to have a second outer diameter which is greater than the first outer diameter D₁, and the outer surface of the liner 80 therefore gets in contact with the inner surface of the composite pipe. The second outer diameter may be equal to the initial internal diameter D₂ of the composite pipe 83, or even greater than D₂. This expansion step may be implemented by guiding a second device 54 through the inside of the liner 80 along e.g., direction 84. Preferably, the expansion of the liner 80 from the first outer diameter to the second outer diameter results in an interference fit between the liner 80 and the composite pipe 83. Additionally or alternatively, the expansion of the liner 80 from the first outer diameter to the second outer diameter may create a mild tension in the composite pipe 83, resulting in a gripping force between the liner 80 and the composite pipe 83, making the pipe assembly rather stable due to the friction force.

The second device 54 is an object pushed, pulled, pumped or otherwise propelled through the inside of the liner with the purpose of changing the cross-sectional shape of the liner. Liners in different examples might have different original cross-sectional shapes and therefore the second devices used, and the step(s) of expanding the liner may vary accordingly.

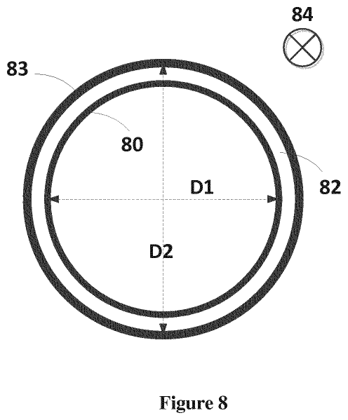

FIG. 6 is a block diagram illustratively showing functional elements of the second device 54 according to embodiments of the invention. The second device 54 in FIG. 6 includes a unit 542 and an expander 546. However, as will be appreciated after reading these examples, in some examples, the second device 54 might only include the unit 542 or only include the expander 546. The second device 54 might also include other elements/components which are not shown in FIG. 6.

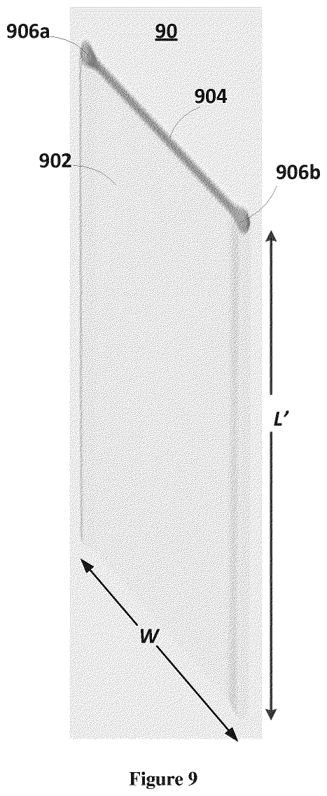

In this Example 1, the liner 80 does not have a flattened part, the second device 54 may mainly or only include an expander 546, an example of which is illustrated in FIG. 7. The expander 546 is formed to be pushed, pulled by e.g., a rod-like component (not shown) through the inside of the liner along e.g., direction 71. An external diameter of the expander 546 is designed in such a way that the expander 546 forces a wall of the liner 80 against the composite pipe 83 and thereby create an interference fit between the liner and the pipe. In an example, the greatest diameter D₃ of the expander 546 may be close or equal to the internal diameter D₂ of the pipe 83, or slightly greater than D₂. Lubricants may be provided for the expander 546 and any other elements of the second device 54 to lower the friction with the inner wall of the liner 80, and may also prevent material interference (for example galling) between the expander 546 and the liner 80. The lubricants may be injected into the liner before placing the second device 54 inside the liner. In some embodiments, the expander 546 forces the wall of the liner against the pipe to plastically expand the liner and achieve an interference fit between the pipe and the liner.

Expander 546 in FIG. 7 includes two cone elements 5462 and 5464 and therefore looks like a camel. In other examples, the expander may have more cone elements, or have only one cone element. Usually, having more than one cone elements may improve the interference fit and ensure stability of the expander 546 while the expander 546 propels through the inside of the liner 80.

The cone elements may be rigid for applications where, for example, the composite pipe has a uniformed internal diameter. Operators may select a cone element(s) for a cone element set having a suitable external diameter according to the desired diameter of the liner (and of the composite pipe). To facilitate proper lining in composite pipes with a non-consistent internal diameter or ovality, and to be able to use one expander for liners having different desired diameters, it may be good if the expander 546 has a tunable external diameter. To that end, as shown in FIG. 7, the expander 546 is formed by a group of radially movable metal blades surrounding a rubber bladder 5466. The rubber bladder 5466 allows for variable expansion using hydraulic agent provided therein. By pressurizing hydraulic agent into the bladder 5466, it forces the cone elements 5462 and 5464 to expand radially to change the (greatest) external diameter of the expander 546. By lowering/removing the pressure, the bladder 5466 will become smaller in size and the cone elements 5462 and 5464 consequently have a decreased diameter. Having a tunable diameter is also important for the expander 546 in case the expander must be placed in the pipe in a first direction 73 ahead of the liner 80 and then retrieved in a second direction 71 to expand the liner 80. In that case, the expander 546 may enter and advance inside the composite pipe with a smaller external diameter, and then obtain a greater external diameter so as to force the wall of the liner against the composite pipe and achieve the desired interference fit. When used to expand a liner in a composite pipe which has a non-consistent internal diameter, the bladder 706 may be automatically controlled by a computer to manipulate the working diameter of the cone elements 5462 and 5464 timely. However, the applicant found that for forming a pipe assembly for pipeline applications using the method and system, it is preferable to propel the expander to expand the liner, and retrieve it.

Additionally or alternatively, the liner may be expanded by the unit 542. The unit 542 is configured to, when guided through the inside of the liner, pressurize a hydraulic agent through the inside of the liner to hydraulically expand the liner. The hydraulic agent may include a viscous substance such as lubricants.

A pipe assembly formed in this way is as illustrated in FIG. 1.

### EXAMPLE 2: THE LINER IS FLATTENED OVER AT LEAST A PART OF ITS CONTINUOUS LENGTH L

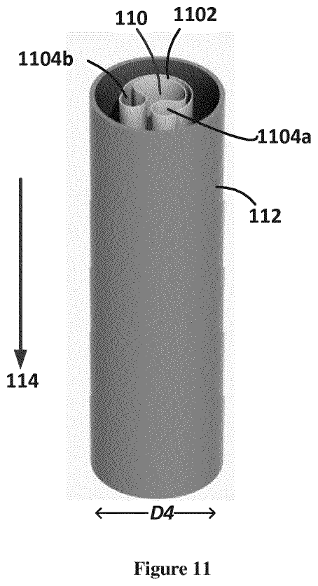

As briefly mentioned referring to FIG. 3, a liner 31 may be coiled into a drum for transportation. However, given the considerable length, its tubular shape may result in a greater drum size. To minimize the drum size and ultimately facilitate the transportation, the applicant found it useful to flatten the liner, over at least a part of its continuous length L. FIG. 9 is an illustration of a flattened part of a liner according to an embodiment of the invention, the flattened part 90 may be formed by performing step 206 on liner 31 over at least a part of its continuous length L.

The flattened part 90 of the liner has a first face 902, a second face 904, separated by two creases 906a and 906b (also referred to “ears”) each formed (in e.g., step 206) at one end of the cross section of the flattened part 90. Each crease extends along the length L′ of the flattened part 90. A cross section of each crease may be circular to reduce the stresses and deformation on the liner material during flattening, coiling (winding) and the pipeline-assembly forming. A rubber slab (not shown) may be coiled with the liner and esp., the flattened part 90 to prevent excess loading on the creases 906a and 906b during the coiling and transportation.

At a second site, the liner having such a flattened part 90 is coiled into a drum, transported to the third site, and then uncoiled, as an implementation of step 403 of method 40. The first outer diameter of the liner is therefore mainly referring to the diameter of the flattened part 90, which will evolve to the second outer diameter by opening and further expanding the flattened part, as described later.

In this and some other examples, expanding the liner to have a second outer diameter may be implemented by opening the flattened part of the liner which has a first (flattened/collapsed) outer diameter to the second outer diameter. The second outer diameter may be selected such that the outer surface of the expanded liner engages the inner surface of the composite pipe with or without applying a mechanical load to the pipe. The inner surface of the composite pipe is, as previously mentioned, at least partially made by polymeric materials.

Example 2 may have several scenarios, method 40 and system 50 will be described in detail referring to these scenarios.

### Scenario 1

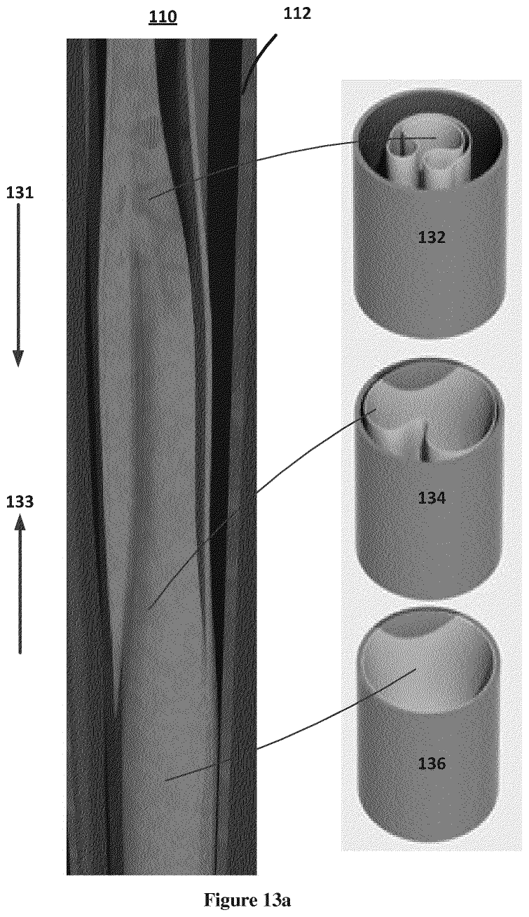

In this scenario, cross section of the flattened part 90 of the liner is folded to a more compact shape, e.g., a C or U shape, before the liner is placed into the pipe in step 406. This may be useful in case the width W of the flattened part of the liner is greater than the internal diameter of the pipe (see e.g., D₄ in FIG. 11).

This folding process further requires steps 404 in method 40, and further requires the third device 56 in system 50.

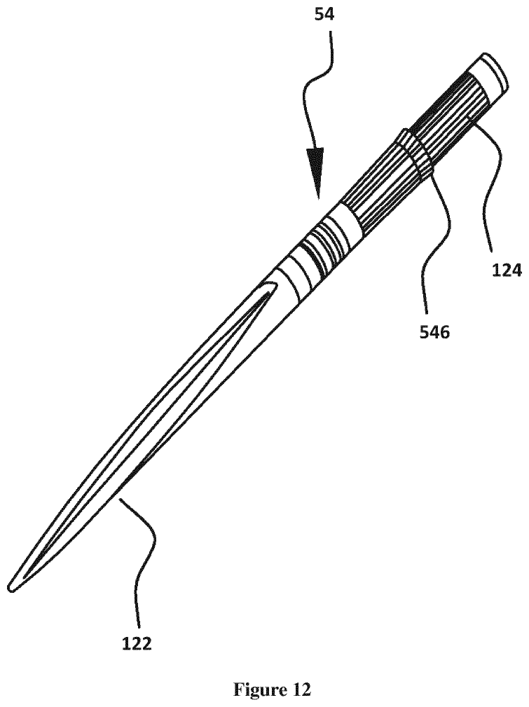

FIG. 10 is an illustration of a third device 56 folding a flattened part of a liner 100 according to an embodiment of the invention. The third device 56 is implemented by a roll forming street. In step 404, the folding is done by running the flattened part of the liner 100 through the roll forming street, and the cross section of the flattened part is changed into a C-like shape, as shown at the bottom part of FIG. 10. The two creases 1002a and 1002b are remained after this folding step.

After the folding, in step 406, the liner is placed in the composite pipe by the first device 52 as previously described, resulting in an assembly as shown in FIG. 11, the liner 110 may be inserted into the composite pipe 112 along direction 114.

Referring to FIG. 11, the second device 54 is then expected to be guided though the inside of the liner 110, starting from the longitudinal end 1102. However, in this scenario, and differently from Scenario 2 to be described later, the longitudinal end 1102 is not suitably opened for the second device 54 to enter, this is typically the case where the liner is flattened over its entire length L and thus L is equal to L′. The end 1102 thus needs to be suitably opened in step 408 by the fourth device 58.

The fourth device 58 may be implemented in such a way that it creates, in step 408, a high air pressure inside the longitudinal end 1102 which is then opened by the pressure difference between the inside and outside of the end 1102. Alternatively, the fourth device 58 may be implemented in such a way that, in step 408, it fills the internal cross section of the flattened end 1102 with water and consequently frozen the water by applying a low temperature, the change in volume of the water by freezing it into ice creates an enlarged opening of the longitudinal end 1102.

Additionally or alternatively, the fourth device 58 may include mechanical means such as hammers to finish opening the longitudinal end 1102 in step 408.

The fourth device 58 thereby leaves ample space to insert the second device 54 into the end 1102 and the method 40 proceeds to step 410 in which the liner 110 will be expanded by opening and expanding the rest part of the liner by guiding the second device 54 through the inside of it.

As mentioned, the second device 54 may be formed by either one of or a combination the unit 542 and the expander 546, to fit the purpose of step 410 when guided through the inside of the liner.

In this scenario, the unit 542 is configured to, when guided through the inside of the liner 110, pressurize a hydraulic agent through the inside of the liner to hydraulically expand the liner. Specifically, the expansion may include opening the flattened part of the liner and further expand it to the second outer diameter which is equal to the internal diameter of the composite pipe, e.g., being around 99% of the internal diameter. The second outer diameter can also be a bit greater than the original internal diameter of the composite pipe. The hydraulic agent may include a viscous substance such as lubricants. The internal diameter of the composite pipe may or may not change due to the expansion of the liner. The expansion mainly increases the outer diameter of the liner so the outer surface of the liner gets in contact with the inner surface of the composite pipe.

Optionally, a part of the unit 542 may have an exterial shape designed according to a desired shape of the liner, e.g., tubular, and that part of unit 542 is further configured to, when guided through the inside of the liner, to open the flattened part of the liner by a mechanical interaction with the liner.

For step 410, the liner may be clamped in a way that the liner is fixated, enabling the second device 54 to be propelled through the liner.

The expander 546, as previously described with reference to FIG. 7, may be used in combination with unit 542, or used independently. In an embodiment, the expander 546 may include multiple cone elements having different external diameters, and the smaller cone element(s) is used to open the flattened part of the liner, and the larger cone element(s) is used to e.g., further open the flattened part and/or create a surplus expansion of the liner to achieve an interference fit between the liner and the pipe by expanding the liner to have a second outer diameter. In this case, the cone elements shall be placed with respect to each other in such a way that in step 410, the smaller cone element(s) propels ahead of the larger one(s).

### Scenario 2

In this scenario 2, the liner has a flattened part and a suitably opened longitudinal end which is suitable for the second device 54. In this case, step 404 and the third device 56 may still apply, step 408 and the fourth device 58 are however not required. The other steps, devices, units in Scenarios 1 and 2 are similar and therefore will not be mentioned here.

### Scenario 3

If the materials selected and the property of the liner allows, the liner may be placed in the composite pipe without folding the cross-section of the flattened part of the liner. In other words, method 40 proceeds from steps 402 and 403 directly to step 406, in which a liner having a flattened part as shown in FIG. 9 is inserted in the composite pipe directly by the first device 52. If the liner does not have a suitably opened longitudinal end, step 408 and the fourth device 58 may be needed to open the end of the liner before step 410, as similarly mentioned for Scenario 1.

In this Scenario 3, in step 410, the liner may be expanded by the unit 542, the expander 546, or a combination thereof. Though it might worth notice that this scenario might be more selective in terms of the materials of the liner, knowing a surplus expansion of the liner in this scenario is greater than those in Scenarios 1 and 2, if the liner must be expanded to create an interference fit between the liner and the pipe. Spring back of the composite pipe and the robustness of the liner forms a stable assembly.

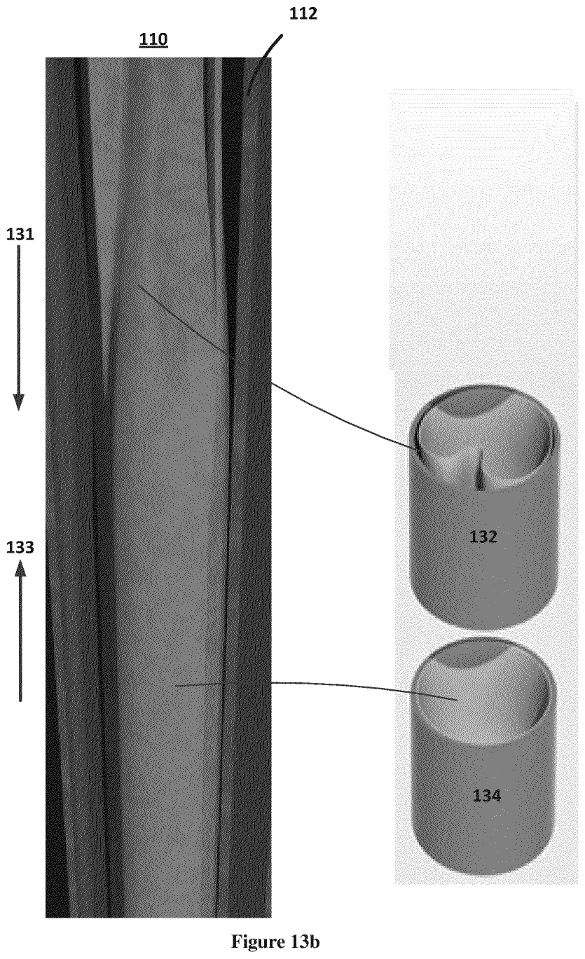

FIG. 12 illustrates a second device 54 according to a preferred example. This second device 54 is an implementation of the one shown in FIGS. 5 and 6. The second device 54 may be retrieved after step 410. The second device 130 comprises the following, which are interconnected to form the spike-like second device 54:

Unit 122 (an equivalence of the unit 542, also referred to as a “nose”): it propels ahead of the rest of the second device 54 and pressurizes a hydraulic agent through the inside of the liner to hydraulically open (unfold) the flattened part of the liner, and/or open (unfold) the flattened part of the liner by physical interaction with the inner surface of the liner. A front part of the nose pressurizes a hydraulic agent with at least a front part of it through the inside of the liner to at least partly open the flattened part of the liner. The rear part of the nose 122 may have a selected external diameter which is suitable to further open the flattened part of the liner by mechanically interact with the inner wall of the flattened part of the liner, after that part has been at least partly opened hydraulically. The hydraulic agent may be viscous substance such as lubricating compound which may also lower the friction between the second device and the liner. The rear part of the nose 122 may be especially useful if after hydraulic opening the liner is not yet in the desired circular shape.

Expander 546: the expander 546 is as described above with reference to FIG. 7. In step 410, it is trailing behind the nose 122, to further expand the liner to have a second outer diameter, and preferably create a forced fit between the liner and the pipe. If the outer surface of the liner is provided with adhesive coating, the contact between the liner and pipe will be further enhanced by the adhesive bonding. The adhesive coating might be applied when inserting the liner into the composite pipe. Said adhesive coating may include a heat activated adhesive, which can be activated by introducing fluids of a relatively high temperature into the pipe assembly.

Hydraulic accumulator 124: in liquid communication with the expander 546, configured to tune the working diameter of the cone elements of the expander 546 with a hydraulic agent.

As previously mentioned, in some embodiments, the expander 546 may be optional. In other embodiments, the nose 122 might be designed to be only able to hydraulically open/unfold the liner, without any direct mechanical interaction with the liner wall of the liner.

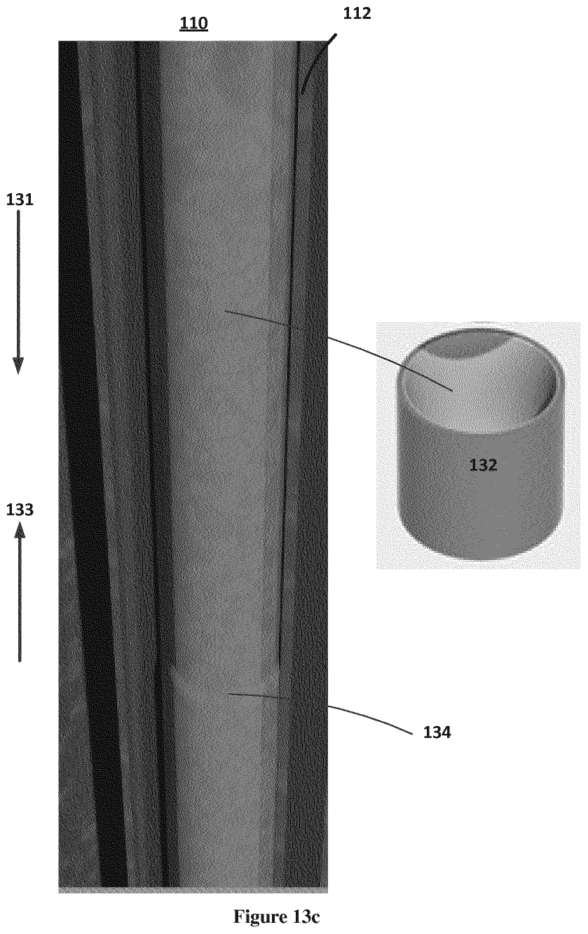

FIGS. 13a-13c illustrates the same section of a composite pipe at different moments in time when forming a pipe assembly using a method/system according to an embodiment of the invention. Without loss of generality, FIGS. 13a-13c will be further described with further reference to FIGS. 11 and 12, in step 406, the second device 54 is inserted into the composite pipe 112 along the first direction 131 followed by the liner 110, and in step 410, the second device 120 is retrieved by being guided along the second direction 133 through the inside of the liner 110. The second direction 133 is opposite to the first direction 141.

To better illustrate the interaction between the second device 54 and the liner 110, several parts of the section are provided with an enlarged view at the right-hand side of each drawing, showing the changing shape of the liner when the second device 54 is advancing along the second direction 133.

See FIG. 13a which corresponds to moment T₀, the second device 120 (covered in the liner and not shown) is being retrieved along direction 133. The nose 122 of the second device 54 is somewhere around the part 134 and part 136. The part 136 of the liner 110 is restored to a circular shape after being hydraulic opened/unfolded and optionally after a further mechanical interaction with the nose 122. The part 134 is at least partially opened by the hydraulic force, however, the creases are still there. The part 132 is not yet reached by the hydraulic agent, so it remains a C-shape as similarly shown in FIG. 11.

The second device 54 continue to propel and at a later moment of time T₁, the section of liner 110 is as illustrated in FIG. 13b. The nose 122 of the second device 54 is now around the parts 132 and 134, and the part 132 is partially opened by the hydraulic agent. The part 134 is now restored to a circular shape after hydraulically opening/unfolding and the mechanical interaction with the nose 122. There is no surplus expansion of the liner in this section yet, indicating the expander 546 may have not reached this section.

The second device 54 further propels and at a yet later moment of time T₂, the section of liner 110 is as illustrated in FIG. 14c. The part 132 is sufficiently restored to a circular shape, and the part 134 is now subject to a further expansion forced by the expander 546. An interference fit is being created between the pipe 112 and the liner 110 at that part 134 which is being expended to have a second outer diameter.

Additional sealing assemblies may be installed at the ends of the liner to mechanically lock the liner in place and/or seal the liner off. This sealing assembly can have a secondary function to provide a conduit to a connector piece that can be used to connect to ends of the pipe assembly. It can also transfer forces to the connection system, from the liner and/or the pipe.

Forming a pipe assembly by combining a CRA liner with a composite pipe provides a relatively low cost option while providing the superior corrosion resistance properties of high-performance steel or solid CRA pipeline.

In an example, the second device might be guided through the liner to expand the liner and retrieved after the expansion.

In an example, the pipe assembly can be used for instance as a flow line to connect a well head to a production manifold.

The present disclosure is not limited to the embodiments as described above and the appended claims. Many modifications are conceivable and features of respective embodiments may be combined. For example, to expand a liner by a second device, the operators can either keep the liner stable and move the second device, or keep the second device stable and move the liner (and the pipe), these shall both be considered as expanding the liner by guiding the second device through the inside of the liner.

1. A method for forming a pipe assembly, comprising:
a. providing a composite pipe having an inner diameter;
b. providing a liner having a first outer diameter which is smaller than the inner diameter of the composite pipe;
c. placing the liner in the composite pipe; and
d. expanding the liner such that the liner has a second outer diameter which is greater than the first outer diameter, and an outer surface of the liner is in contact with an inner surface of the composite pipe, so as to form a pipe assembly including said composite pipe and said liner.

2. The method of claim 1, wherein the inner surface of the composite pipe is at least partially formed by a polymeric material.

3. The method of claim 2, wherein the polymeric material is reactable with and/or permeable to hydrocarbons.

4. The method of claim 3, wherein the composite pipe further comprises an adhesive layer outside said inner surface, the adhesive layer is reactable with hydrocarbons.

5. The method of claim 1, further comprising:
forming the composite pipe at a first site;
forming the liner at a second site; and
transporting the composite pipe and the liner to a third site;
wherein steps a-d are conducted at the third site where the pipe assembly is installed to a pipeline system, as an in situ part of the installation process, the first site, the second site and the third site being different from each other.

6. The method of claim 1, wherein the second outer diameter is selected such that an interference fit is created between the liner and the composite pipe when the liner is expanded to have the second outer diameter.

7. A system for forming a pipe assembly, comprising:
a first device configured to place a liner in a composite pipe, the liner having a first outer diameter which is smaller than an inner diameter of the composite pipe;
a second device configured to expand the liner such that the liner has a second outer diameter which is greater than the first outer diameter, and an outer surface of the liner is in contact with the inner surface of the composite pipe, so as to form a pipe assembly including said composite pipe and said liner.

8. The system of claim 7, wherein the inner surface of the composite pipe is at least partially formed by a polymeric material.

9. The system of claim 8, wherein the polymeric material is reactable with and/or permeable to hydrocarbons.

10. The system of claim 9, wherein the composite pipe further comprises an adhesive layer outside said inner surface, the adhesive layer is reactable with hydrocarbons.

11. The system of claim 7, wherein the composite pipe is formed at a first site, the liner is formed at a second site, the composite pipe and the liner are transported to a third site where the system forms the pipe assembly and the pipe assembly is installed to a pipeline system, the first site, the second site and the third site being different from each other.

12. The system of claim 7, wherein the second outer diameter is selected such that an interference fit is created between the liner and the composite pipe when the liner is expanded to have the second outer diameter.

13. The system of claim 7, wherein the second device comprises one or more of the following:
a unit configured to pressurize a hydraulic agent into the liner to hydraulically expand the liner; or
an expander configured to be guided through the inside of the liner to expand the liner with a mechanical interaction between an exterior surface of the expander and an inner surface of the liner, an exterior diameter of the expander being selected according to the second outer diameter of the liner.

14. The system of claim 13, the expander comprises one or more cone elements, an exterial diameter of each cone element being tunable according to the internal diameter of the composite pipe.

15. (canceled)

16. A pipe assembly made by the method of claim 1.

17. A pipe assembly made by the system of claim 7.
